(19) United States
(12) Patent Application Publication
(10) Pub. No.: US 2008/0139054 A1
(43) Pub. Date: Jun. 12, 2008

(54) Systems and methods for powered tap assemblies

(76) Inventors: Cory R. Williamson, Bozeman, MT (US); Martin Albini, Bozeman, MT (US); Thomas J. Wernikowski, Bozeman, MT (US); Christian P. Burrows, Tacoma, WA (US); Mark Gentzen, Bellevue, WA (US); Paul Daniel Fichter, Seattle, WA (US)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(21) Appl. No.: 11/637,164

(22) Filed: Dec. 12, 2006

Related U.S. Application Data
(60) Provisional application No. 60/873,953, filed on Dec. 11, 2006.

(51) Int. Cl. H01R 4/30

(52) U.S. Cl. 439/801

(57) ABSTRACT

The present invention relates to systems and methods for providing electrical power to a tap handle on a beverage dispenser. Specifically, the present invention may be used to provide electrical power to beer tap handles.

### CROSS REFERENCE TO RELATED APPLICATIONS

This application claims the benefit under 35 U.S.C. §119, of provisional U.S. application Ser. No. [Unassigned], filed Dec.11, 2006, the entire contents and substance of which is hereby incorporated by reference.

### FIELD OF THE INVENTION

The present invention relates to systems and methods for providing electrical power to a tap assembly on a beverage dispenser.

### BACKGROUND OF THE INVENTION

Bar taps are well known, and are traditionally used in conjunction with a beverage dispenser to control the release of the beverage. Normally, the beverage dispenser will have one or more tap stems, to which a decorative tap handle may be attached. Decorative tap handles are designed and used to let customers know that a certain beverage is available and to entice them to try that beverage.

Specifically and in one non-limiting example, beer breweries create tap handles of all shapes and sizes to brand their product, to lure new customers to try their beer and/or to let existing customers know which of their particular beverages are available at a given establishment. Indeed, decorative beer tap handles are often the primary marketing vehicle for some smaller scale breweries, such as micro and craft breweries. These breweries often rely on the eye-catching ability of their decorative tap handle to generate business and enlarge their customer base.

However, traditional decorative tap handles, which are commonly made of plastic or wood, have certain limitations. Specifically, and as currently used, these traditional handles are not provided with electrical power. By lacking electrical power, the traditional tap handles can only be effective marketing tools if the potential customer is already looking at the tap, as the non-powered handles are unable to draw attention in the way that an electrically-powered lighted, sound producing or moving tap handle could.

The benefits of providing powered tap handles and a method for achieving the same has been previously addressed in U.S. Pat. No. 6,932,638 (the '638 patent), which is co-owned and fully incorporated by reference herein. While the design described in the '638 patent provided a number of important advances, certain drawbacks that made the mounting and use of the described beer tap assemblies more difficult than necessary in some circumstances remained. For example, in the systems described in the '638 patent, an insulated conductive wire entered the assembly through a hole in a bushing that rotated freely around the locknut. The wire then traveled between the bushing and the locknut. This configuration generated a number of unanticipated drawbacks. For example, the orientation of the wire, when it exited the hole in the bushing, could not be controlled. This lack of control had the dual results of limiting the possible configurations of the tap assembly and being aesthetically unpleasing (potentially resulting in the loss of advertising effectiveness). Further, the wire was unprotected as it entered the hole, which often resulted in fraying or breakage. In addition, the wire would get pinched between the bushing and the locknut, which also resulted in frequent fraying and breakage. Moreover, the hole in the bushing allowed particles to enter into the cavity between the bushing and the locknut, which often resulted in the bushing losing its rotational independence, as well as adding yet another source of wear on the wire. As a final example of drawbacks associated with the systems described in the '638 patent, these systems failed to provide for a reliable mechanism for attaching the bushing to the locknut. This lack of reliable attachment resulted in the bushing frequently falling off of the locknut, thus crippling both the effectiveness and aesthetic appeal of the '638 system. The '638 system also left room for improvement in the attachment of tap handles to the tap assembly. Thus, despite the advancements provided by the '638 patent, there is still significant room for improvement in providing powered tap assemblies.

### SUMMARY OF THE INVENTION

The present invention addresses drawbacks associated with prior powered tap assembly designs by providing systems and methods that allow for independent rotation of a particular tap assembly's conductive wire entry point as compared to the rest of the tap assembly while also allowing for the control of the wire's final orientation and protection of the wire at its entry point into the tap assembly and while also providing a design that maintains the integrity of the powered tap assembly by preventing dirt or other debris from entering relevant portions of the assembly through the wire's entry point. The present invention provides this benefit by providing a slip ring with a conductive wire entry point between each tap assembly's locknut and ferrule assembly. The slip rings according to the present invention can rotate independently as compared to the other components of the tap assembly. Further, the slip rings provide a novel way for electrical power to enter into a tap handle. Specifically, the slip ring acts to control the direction of the wire as it enters into the tap assembly. Further, the slip ring design advantageously provides a connection which is protected and subjected to much less fraying and breakage than previously designed powered tap handle systems. The slip ring also provides a reliable mechanism for maintaining rotational independence that is less likely to break down with consistent use. In addition, the ferule assembly of the present invention provides a reliable mechanism for attaching a tap handle to a powered tap assembly. The present invention also provides for a tap assembly that is sleeker and more attractive than previous systems, which is important given the use of tap handles for advertising.

Specifically, one embodiment according to the present invention comprises a tap assembly comprising a locknut; a slip ring; and a ferrule assembly; wherein the slip ring is positioned between the locknut and the ferrule assembly; wherein the rotational position of the slip ring can be adjusted relative to the rotational positions of the locknut and/or the ferrule assembly; and wherein the slip ring can accept conductive wires into the tap assembly so that the wires can provide power to the tap assembly.

In another embodiment according to the present invention, the slip ring comprises one or more conductive elements. In certain embodiments, the conductive elements can be conductive rings. Slip rings according to the present invention can also comprise an overmold.

Ferrule assemblies used in accordance with the present invention can comprise a circuit board, a ferrule base, a ferrule wire, and a ferrule stud. Locknuts can comprise a vertical indentation to restrict vertical movement of the slip ring.

One embodiment according to the present invention comprises a powered tap handle system comprising a tap assembly and a power supply system wherein the tap assembly comprises a locknut; a slip ring; and a ferrule assembly, wherein the slip ring is positioned between the locknut and the ferrule assembly; and wherein the rotational position of the slip ring can be adjusted relative to the rotational positions of the locknut and/or the ferrule assembly; and wherein the power supply system comprises a non-conductive protective layer comprising a top surface and a bottom surface; a non-conductive support layer comprising a top surface and a bottom surface; a first conductive material; and a second conductive material, wherein the first conductive material and the second conductive material are located between the top surface of the protective layer and the bottom surface of the support layer and wherein the non-conductive support layer is shaped to allow access to the first conductive material and the second conductive material by a first conductive contact associated with a first conductive wire and a second conductive contact associated with a second conductive wire, wherein when engaged to the first and second conductive materials the first and second conductive contacts and associated conductive wires carry power to the tap assembly via an entry point in the slip ring.

In another embodiment of a powered tap handle system according to the present invention, the slip ring comprises one or more conductive elements and the ferrule assembly comprises a circuit board, a ferrule base, a ferrule wire, and a ferrule stud.

The present invention also includes a ferrule assembly for use with a tap assembly wherein the tap assembly comprises a locknut and a slip ring comprising one or more conductive elements; wherein the slip ring is positioned between the locknut and the ferrule assembly; and wherein the slip ring can accept conductive wires into the tap assembly so that the wires can provide power to the tap assembly. In certain embodiments according to present invention, the ferrule assembly comprises a circuit board, a ferrule base, a ferrule wire, and a ferrule stud.

The present invention also includes a slip ring for use with a tap assembly wherein the tap assembly comprises a locknut and a ferrule assembly comprising a circuit board, a ferrule base, a ferrule wire, and a ferrule stud wherein the slip ring is positioned between the locknut and the ferrule assembly and wherein the rotational position of the slip ring can be adjusted relative to the rotational positions of the locknut and/or the ferrule assembly; and wherein the slip ring can accept conductive wires into the tap assembly so that the wires can provide power to the tap assembly.

Slip rings of the present invention can comprise one or more conductive elements. In certain embodiments, the conductive elements can be conductive rings. In further embodiments, the rotational position of the slip ring can be adjusted relative to the rotational positions of the locknut and/or the ferrule assembly. Slip rings can also comprise overmolds in certain embodiments and, when desired, can be sized to fit into a vertical indentation which is found on the locknut in certain specific embodiments.

The present invention also includes methods. One method according to the present invention includes a method for accepting power into a tap assembly comprising providing a locknut; providing a slip ring; and providing a ferrule assembly, wherein the slip ring is positioned between the locknut and the ferrule assembly; and wherein the slip ring accepts conductive wires into the tap assembly so that the wires can provide power to the tap assembly.

In another embodiment of the methods according to the present invention, the slip ring comprises one or more conductive elements. In another embodiment the rotational position of the slip ring can be adjusted relative to the rotational positions of the locknut and/or the ferrule assembly and the slip ring can further comprise an overmold.

In another embodiment of the methods according to the present invention the ferrule assembly comprises a circuit board, a ferrule base, a ferrule wire, and a ferrule stud.

The present invention also includes tap handles for use with the tap assemblies described herein. In one embodiment, the present invention includes a tap handle for use with a tap assembly wherein the tap assembly comprises a locknut; a slip ring; and a ferrule assembly comprising a circuit board, a ferrule base, a ferrule wire, and a ferrule stud, wherein the slip ring is positioned between the locknut and the ferrule assembly; wherein the rotational position of the slip ring can be adjusted relative to the rotational positions of the locknut and/or the ferrule assembly; wherein the slip ring can accept conductive wires into the tap assembly so that the wires can provide power to the tap assembly and wherein the tap handle is attached to the ferrule stud. In another embodiment, the slip ring comprises one or more conductive elements. In another embodiment of the tap handles according to the present invention, the tap handle performs a function selected from the group consisting of lighting, producing sound, moving, vibrating, and combinations thereof.

### BRIEF DESCRIPTION OF THE DRAWINGS

FIG. 1 is a diagram of one specific embodiment of a tap assembly according to the present invention.

FIG. 2A is a diagram of the locknut of one specific embodiment of a tap assembly according to the present invention. FIG. 2B shows a cross section of a tap stem, locknut and slip ring according to the present invention showing a vertical indentation on the locknut.

FIG. 3 is a diagram of the slip ring of one specific embodiment of a tap assembly according to the present invention.

FIG. 4 is a cross-sectional diagram of the slip ring of one specific embodiment of a tap assembly according to the present invention.

FIG. 5 is a diagram of the ferrule assembly of one specific embodiment of a tap assembly according to the present invention.

FIG. 6 is a cross-sectional diagram of one specific embodiment of an electrical power supply that can be used in accordance with the present invention.

FIG. 7 is a perspective view of one specific embodiment of an electrical power supply system that can be used in accordance with the present invention.

FIG. 8 is a cross-sectional diagram of one specific embodiment of an electrical power supply system that can be used in accordance with the present invention.

FIG. 9 is a perspective view of a tap assembly according to the present invention being powered by an appropriate power supply.

### DETAILED DESCRIPTION

Existing tap handles as they are presently used in commercial establishments fail to capitalize on their full advertising potential by failing to effectively draw attention to the beverage with which they are associated. While this drawback was addressed in U.S. Pat. No. 6,932,638 (the '638 patent), which is fully incorporated by reference herein, the systems and methods described in the '638 patent had certain design features that could make their mounting and use more difficult than necessary in some circumstances. For example, due to a problematic wire entry position, those systems and methods had limited configurations. The previous mechanism for wire entry also often resulted in the wire fraying and breakage, thus crippling the functionality of the systems. Further, the '638 system was problematic in that it could not maintain the rotational independence of the wire entry point over a sustained period of time. The present invention addresses these drawbacks of previous approaches and provides a system for transferring electrical power to tap handles so that the handles can move, produce sound, light up, etc. in order to draw the eye of potential customers. Further, the systems and methods of the present invention also provide an advance in the ease and effectiveness with which powered tap assemblies can be mounted and used. The systems and methods according to the present invention address the drawbacks of previously used systems in part by providing for a slip ring in the tap assembly design that provides for independent movement of the wire entry point. This advance also facilitates mounting the tap assemblies in various configurations, and prevents the wires from undue incidences of fraying and/or breakage. The slip ring system also provides a more robust and protective mechanism while maintaining the rotational independence of the wire entry point.

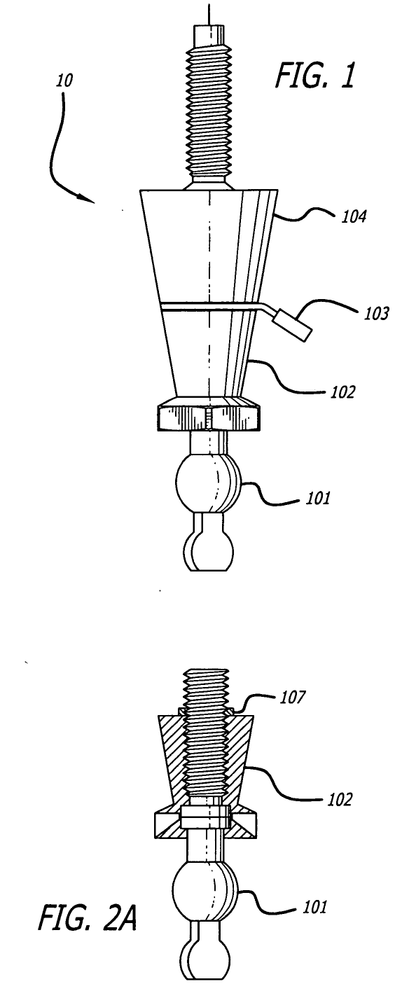

Referring to the Figures, FIG. 1 depicts a perspective view of one specific embodiment of a tap assembly according to the present invention. As shown in FIG. 1, tap assembly 10 is adapted to work in conjunction with tap stem 101. Tap stem 101 is an existing tap stem as known to one of ordinary skill in the art, and as such controls the flow of a beverage through a tap such as, without limitation, a pressure-dispense bar tap used to dispense beer or some other draught beverage. The upper portion of standard tap stems are typically substantially cylindrical in shape with a ⅜ inch diameter, and are normally outfitted with standard, male thread (typically 16 UNC (16 threads per inch, American Standard, Unified Coarse Thread Series, as defined under ANSI B 1.1)). Tap stem 101 may comprise such a standard upper tap stem portion, though it may also comprise any non-standard tap stem, including a tap stem with an alternative diameter or threading.

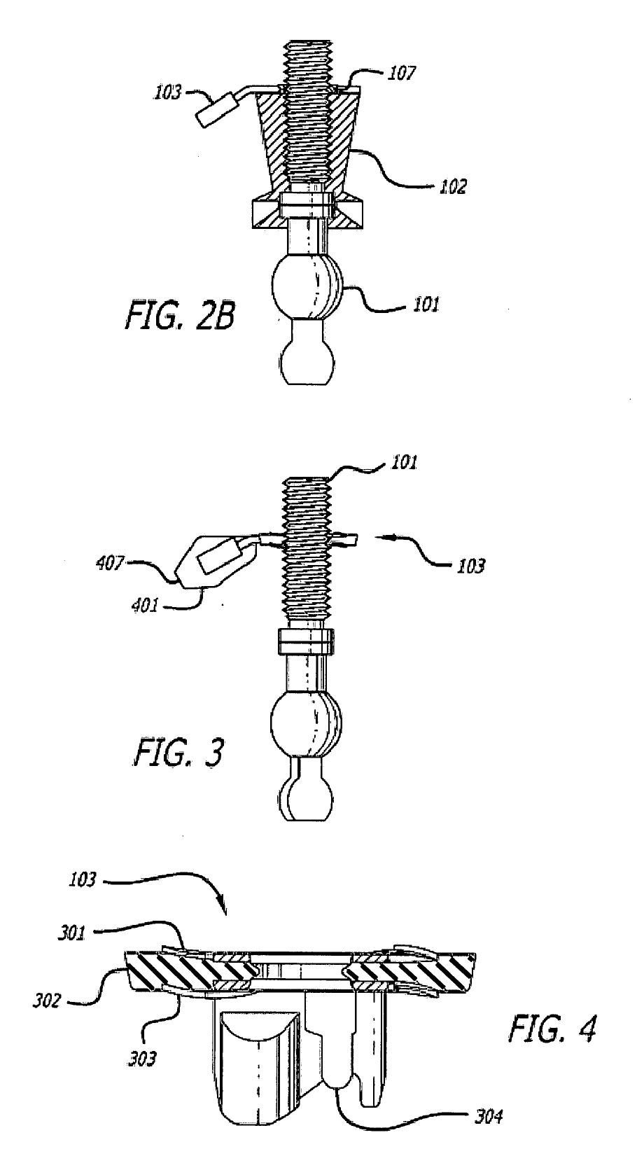

As shown in FIG. 1, tap assembly 10 also comprises a locknut 102, a slip ring 103, and a ferrule assembly 104. Slip ring 103 is positioned between locknut 102 and ferrule assembly 104. Turning to FIG. 2A, it can be seen that locknut 102 is adapted to be receivable onto tap stem 101. If tap stem 101 is outfitted with a standard upper tap stem as discussed above, locknut 102 comprises a female threaded ⅜ diameter, 16 UNC, screw hole. Alternatively, if tap stem 101 is non-standard, locknut 102 is adapted to be receivable onto that non-standard tap stem 101. In specific embodiments, locknut 102 may comprise any conductive material as understood by one of ordinary skill in the art, and may specifically comprise any appropriate metal such as, without limitation, copper, brass, chrome plated brass, silver, aluminum, steel, gold, tin, lead, nickel, or an alloy; any appropriate non-metallic conductor such as, without limitation, graphite; or any combination thereof. In most embodiments according to the present invention, and as will be described in more detail below, locknut 102 is conductive to provide a portion of the required neutral ground in the systems and methods according to the present invention. In specific embodiments, locknut 102 comprises a vertical indentation 107 (see also FIG. 2B) that slip ring 103 may slide or snap into. This vertical indentation 107 can help to hold slip ring 103 in place vertically, yet allows slip ring 103 to turn rotationally, independent of locknut 102, as needed, for instance during installation and/or use of the systems and methods described herein.

As shown in FIGS. 2B and 3, slip ring 103 is adapted to encircle tap stem 101. Slip ring 103 provides an entry point 407 through which conductive wires (not shown) can enter the tap assembly. In certain embodiments, slip ring 103 may further comprise an overmold 401 around entry point 407. Overmold 401 can serve as a protective cover for the connection between slip ring 103 and the electrical leads from the power supply discussed below. Overmold 401 may comprise any non-conductive material such as, without limitation, rubber, polyethylene, polyvinyl chloride, impregnated paper, neoprene, plastic, foam, glass, porcelain, composite, and any combinations thereof.

Moving on to FIG. 4, in certain embodiments slip ring 103 can comprise two conductive rings separated by a nonconductive ring. In a specific embodiment, and as depicted in FIG. 4, slip ring 103 may comprise an upper conductive ring 301 and a lower conductive ring 303, which are separated vertically by nonconductive ring 302. Conductive rings 301, 303 may comprise any conductive material as understood by one of ordinary skill in the art, and may specifically comprise any appropriate metal such as, without limitation, copper, silver, aluminum, steel, gold, tin, lead, nickel, or an alloy; any appropriate non-metallic conductor such as, without limitation, graphite; or any combination thereof. Conductive rings 301, 303 may be flat, stamped into a wave pattern (as shown in FIG. 4), fitted with ribs, or otherwise configured to facilitate contact with locknut 102 and ferrule assembly 104. Nonconductive ring 302 may comprise any non-conductive material as understood by one of ordinary skill in the art, and may specifically comprise, without limitation, rubber, nylon, polyethylene, polyvinyl chloride, impregnated paper, neoprene, plastic, foam, glass, porcelain, composite, or any combination thereof.

As shown in FIG. 4, in specific embodiments each conductive ring 301, 303 may also comprise a protruding member 304 to facilitate the transfer of electrical power to each respective conductive ring 301, 303. The protruding members 304 each extend into entry point 407, where they may be crimped, soldered, or otherwise connected to conductive wires (not shown). The protruding members 304 are separated, like conductive rings 301, 303, by nonconductive layer 302. Overmold 401, which may be positioned around entry point 407, serves to protect and reduce disturbance of the connection between the protruding members 304 and the conductive wires.

In other specific embodiments, the conductive wires may be directly crimped, soldered, or otherwise connected to each conductive ring 301, 303. In yet other specific embodiments, the conductive wires may be crimped, soldered, or otherwise connected to two conductive spring connectors, brushes, or other connectors adapted to provide continuous contact with one of conductive rings 301, 303.

In specific embodiments, electrical power may be transferred to slip ring 103. In one such embodiment, a powered lead may be connected to upper conductive ring 301 and a neutral lead may be connected to lower conductive ring 303. In one specific embodiment, the powered lead may have, without limitation, about 6 volts on it and the neutral lead may have about 0 volts on it. As will be understood by one of ordinary skill in the art, however, depending on the intended use for a particular electrical power supply system, various other voltages can be used in accordance with the systems and methods of the present invention.

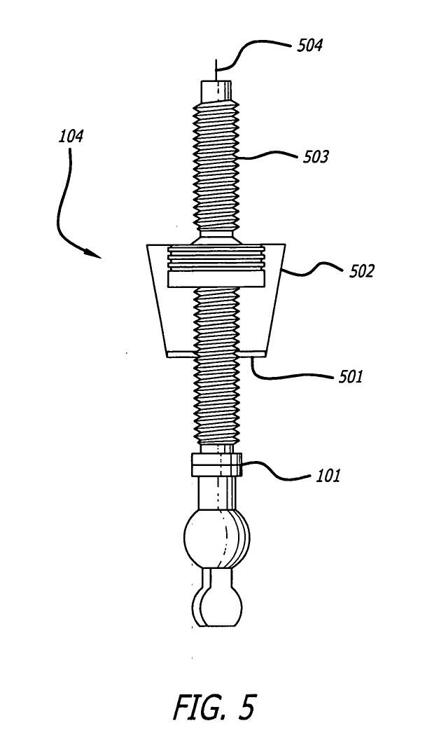

In a specific embodiment shown in FIG. 5, ferrule assembly 104 may comprise circuit board 501, ferrule base 502, ferrule stud 503, and ferrule wire 504. As shown in FIG. 5, ferrule base 502 is adapted to be receivable onto tap stem 101. If tap stem 101 is outfitted with a standard upper tap stem as discussed above, ferrule base 502 comprises a female threaded ⅜ diameter, 16 UNC, screw hole. Alternatively, if tap stem 101 is non-standard, ferrule base 502 is adapted to be receivable onto that non-standard tap stem 101. As shown in FIG. 5, ferrule base 502 is adapted to allow ferrule wire 504 to pass through it. In one embodiment, ferrule base 502 comprises a channel large enough for ferrule wire 504 to pass through. In specific embodiments ferrule wire 504 is insulated and ferrule base 502 comprises any conductive material as understood by one of ordinary skill in the art, and may specifically comprise any appropriate metal such as, without limitation, copper, brass, chrome plated brass, silver, aluminum, steel, gold, tin, lead, nickel, or an alloy; any appropriate non-metallic conductor such as, without limitation, graphite; or any combination thereof. In these embodiments, ferrule base 502 serves as a neutral ground in the systems and methods according to the present invention.

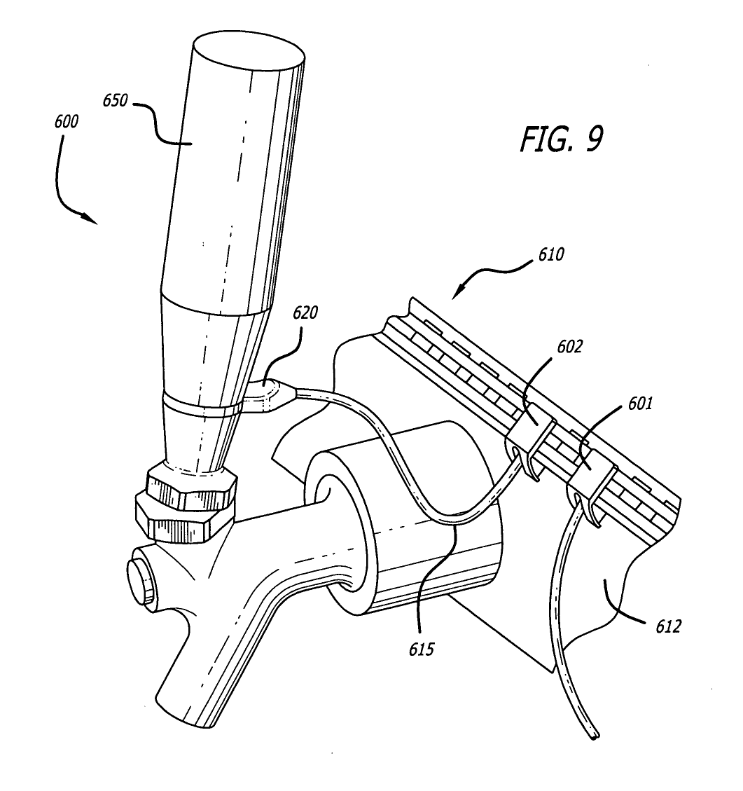

As shown in FIG. 5, ferrule base 502 is also adapted to connect to ferrule stud 503. In one specific embodiment, ferrule base 502 comprises a threaded cavity which ferrule stud 503 may be receivable into. Ferrule stud 503 is adapted to connect to tap handle 650, shown in FIG. 9. In one specific embodiment, ferrule stud 503 comprises a substantially cylindrical upper portion with a ⅜ inch diameter and is outfitted with standard, male thread, typically 16 UNC (16 threads per inch, American Standard, Unified Coarse Thread Series, as defined under ANSI B1.1). Ferrule stud 503 is also adapted to allow ferrule wire 504 to pass through it. In one specific embodiment, ferrule stud 503 comprises a channel large enough for ferrule wire 504 to pass through. When ferrule wire 504 is insulated, ferrule stud 503 may comprise any conductive material as understood by one of ordinary skill in the art, and may specifically comprise any appropriate metal such as, without limitation, copper, brass, chrome plated brass, silver, aluminum, steel, gold, tin, lead, nickel, or an alloy; any appropriate non-metallic conductor such as, without limitation, graphite; or any combination thereof. In these embodiments, ferrule stud 503 also serves as a neutral ground.

Circuit board 501 comprises an electrical contact which, in certain embodiments, engages upper conductive ring 301 although it is understood that various other connection configurations are achievable in accordance with the present invention. In the described embodiments, circuit board 501 is connected to ferrule wire 504, and acts to provide an electrical connection between the upper conductive ring 301 and ferrule wire 504. The connection between circuit board 501 and ferrule wire 504 may be made by soldering, clamping, or any other method of attachment as understood by one of ordinary skill in the art. In a specific embodiment, circuit board 501 may be a printed circuit board. In another embodiment, circuit board 501 may simply comprise a conductive ring similar to those in slip ring 103. In some embodiments, circuit board 501 further comprises an insulating layer that keeps ferrule base 502 from coming in contact with upper conductive ring 301, as well as with any metal portion that contacts upper conductive ring 301. Further, in specific embodiments, the connection between circuit board 501 and ferrule wire 504 is similarly insulated. This insulation is important to prevent shorts, as ferrule base 502 and ferrule stud 504 act as a neutral ground in certain embodiments, while upper conductive ring 301 and ferrule wire 504 act as powered leads.

Ferrule wire 504 serves as a conduit for electrical power to travel from circuit board 501 to tap handle 650 (FIG. 9). Ferrule wire 504 may comprise any conductive material as understood by one of ordinary skill in the art, and may specifically comprise any appropriate metal such as, without limitation, copper, brass, chrome plated brass, silver, aluminum, steel, gold, tin, lead, nickel, or an alloy; any appropriate non-metallic conductor such as, without limitation, graphite; or any combination thereof. As shown, ferrule wire 504 may comprise a round wire. Alternatively, ferrule wire 504 may comprise a flat strip or any other appropriate shape. In specific embodiments, ferrule wire 504 may comprise a flexible or semi-flexible material. Alternatively, ferrule wire 504 may comprise a rigid or semi-rigid material. Ferrule wire 504 may also be insulated.

As discussed above, electrical power may be transferred to slip ring 103, in the manner of a powered lead connected to upper conductive ring 301 and a neutral lead connected to lower conductive ring 303. Also as discussed above, circuit board 501 acts to provide an electrical connection between the upper conductive ring 301 and ferrule wire 504. As such, if a powered lead is connected to upper conductive ring 301, ferrule wire 504 is also a powered lead. In such a situation, a neutral lead would be connected to lower conductive ring 303. Lower conductive ring 303 is designed to contact locknut 102, which is designed to contact tap stem 101 and ferrule base 502, which in turn contacts ferrule stud 503. As each of these components is conductive, they each act as a neutral lead when a neutral lead is connected to lower conductive ring 303.

Of course, in certain embodiments, lower conductive ring 303 may be connected to a powered lead, while upper conductive ring 301 may be connected to the neutral ground. In such an embodiment, the above conductive paths could still hold true, but be updated to powered instead of neutral and vice-versa. Alternatively, the invention may be adapted such that ferrule wire 504 is configured to make electrical contact, via circuit board 501, locknut 102, or ferrule base 502, with lower conductive ring 303.

In a further alternative embodiment, ferrule wire 504 may comprise a wire with two conductive materials which are insulated from each other. In such an embodiment, circuit board 501, locknut 102, and slip ring 103 are configured such that each of the two conductive materials in ferrule wire 504 contacts one of conductive rings 301, 303 and thus act as the powered and neutral lead for tap stem 101.

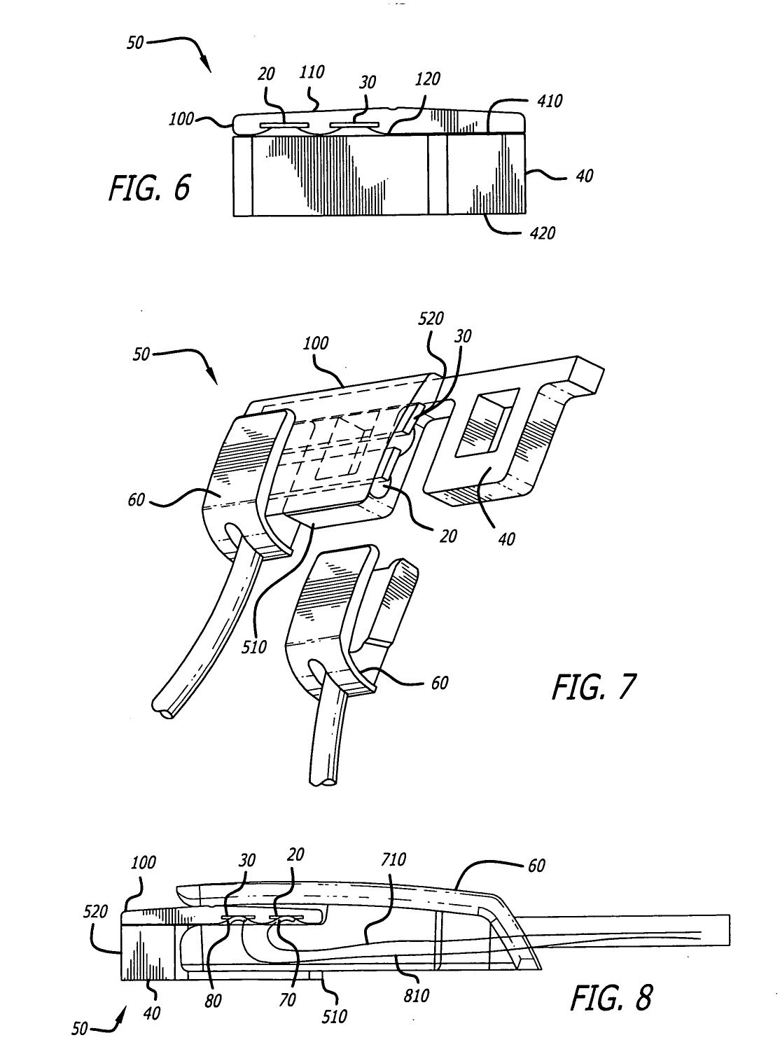

Tap assemblies of the present invention can be used with a variety of power systems, one of which is described herein. This power system is also described in copending U.S. application Ser. No. ______ which is fully incorporated herein by reference. FIG. 6 illustrates a cross-section view of this electrical power supply system. As shown in FIG. 6, electrical power supply system 50 may comprise a first conductive material 20 and a second conductive material 30. Conductive materials 20 and 30 may comprise any conductive material as understood by one of ordinary skill in the art, and may specifically comprise any appropriate metal such as, without limitation, copper, silver, aluminum, steel, gold, tin, lead, nickel, or an alloy; any appropriate non-metallic conductor such as, without limitation, graphite; or any combination thereof. These conductive materials can comprise, without limitation, a flat strip, a round wire or any other appropriate shape. These conductive materials can also comprise a flexible, semi-flexible, rigid or semi-rigid material. In specific embodiments, conductive materials 20 and 30 may be about one sixteenth inch thick, although these dimensions are not required and are provided for exemplary purposes only. Further, while they can be, conductive materials 20 and 30 do not need to be made of the same material or be of the same dimension.

In certain embodiments, first conductive material 20 may act as a powered lead and second conductive material 30 may act as a neutral lead. Alternatively, first conductive material 20 may act as a neutral lead and second conductive material 30 may act as a powered lead. In either embodiment, the powered lead may have, without limitation, below about 6 volts on it and the neutral lead may have about 0 volts on it. As will be understood by one of ordinary skill in the art, however, depending on the intended use for a particular electrical power supply system, various other voltages can be used in accordance with the systems and methods of the present invention.

In addition to a first and second conductive material 20, 30, the described power system also comprises a protective layer 100. As shown, protective layer 100 may comprise a top surface 110 and a bottom surface 120. Protective layer 100 may comprise any non-conductive material as understood by one of ordinary skill in the art, and may specifically comprise, without limitation, rubber, polyethylene, polyvinyl chloride, impregnated paper, neoprene, plastic, foam, glass, porcelain, composite, or any combination thereof. Protective layer 100 may comprise, without limitation, a flexible, semi-flexible, rigid or semi-rigid material. As shown in FIG. 6, in certain embodiments, top surface 110 of protective layer 100 comprises a slightly convex surface. A convex surface can allow liquids to easily run off of top surface 110 and can make top surface 110 easy to clean which is a beneficial feature for use with the tap assemblies of the present invention. Alternatively, top surface 110 of protective layer 100 may comprise some other functional or aesthetically pleasing shape. In specific embodiments, protective layer 100 may be about one quarter inch thick, although this dimension is not required and is provided for exemplary purposes only.

In certain embodiments of these exemplary power supplies used in accordance with the present invention, protective layer 100 acts as a barrier to prevent access to first and second conductive material 20, 30 from one side (in one embodiment the top side) of electrical power supply system 50. In specific embodiments, protective layer 100 may also act to keep first conductive material 20 from coming into contact with second conductive material 30. In other specific embodiments, protective layer 100, first conductive material 20, and second conductive material 30 may be created together as a co-extrusion. Because protective layer 100, in specific embodiments, acts as a barrier between the conductive materials 20, 30 and accidental contact and/or liquid spills, it also blocks access to conductive materials 20, 30 that is necessary to utilize the electrical power supply system 50. As such, a novel way to connect to the conductive materials 20, 30 is needed, and is provided for below.

In addition to first and second conductive material 20, 30 and protective layer 100, the described exemplary power system that can be used with the tap assemblies of the present invention also comprises a support layer 40. As shown in FIG. 6, support layer 40 may comprise a top surface 410 and a bottom surface 420. As can be seen more clearly in FIG. 7, support layer 40 is shaped in such a manner to allow access to first conductive material 20 and second conductive material 30. In the embodiment depicted in FIG. 7, protective layer 100, first conductive material 20, second conductive material 30, and support layer 40 extend together in parallel fashion, and the electrical power supply system 50 has a proximal surface 510 and a distal surface 520. In this depicted embodiment, protective layer 100 and support layer 40 are joined along the entirety of distal surface 520. To allow access to conductive materials 20, 30, support layer 40 extends from distal surface 520 to proximal surface 510 intermittingly.

Support layer 40 may comprise any non-conductive material as understood by one of ordinary skill in the art, and may specifically comprise, without limitation, rubber, polyethylene, polyvinyl chloride, impregnated paper, neoprene, plastic, foam, glass, porcelain, composite, or any combination thereof. In specific embodiments, support layer 40 may comprise a flexible, semi-flexible, rigid or semi-rigid material. In specific embodiments, support layer 40 may be about one quarter inch thick, although this dimension is not required and is provided for exemplary purposes only. Thus, this described power system provides an electrical power supply system that can be used in highly trafficked areas without the risk of inadvertent shock, shorts due to liquid spills or other contact and provides a beneficial power system to be used with tap assemblies of the present invention.

In certain embodiments of the exemplary power systems described herein, the bottom surface 420 of support layer 40 may comprise an adhesive surface. Alternatively, bottom surface 420 of support layer 40 may be otherwise associated with an adhesive (through, without limitation, fastening to an adhesive film, coating with an adhesive substance, etc.). In those specific embodiments wherein bottom surface 420 of support layer 40 is adhesive or otherwise associated with an adhesive, the adhesive may be used to mount electrical power supply system 50 upon various surfaces. Further, the adhesive may be of sufficient strength for permanent mounting, or it may be of a strength needed for temporary mounting.

As shown in FIG. 7, the described electrical power supply system 50 may further comprise one or more connector device(s) 60, which are shown in more detail in FIG. 8. As shown in FIG. 8, connector device(s) 60 may comprise a first conductive contact 70 and a second conductive contact 80. In specific embodiments, first conductive contact 70 and second conductive contact 80 may comprise spring clips. In one specific embodiment, and as shown in FIG. 8, first conductive contact 70 is designed to engage first conductive material 20 and second conductive contact 80 is designed to engage second conductive material 30. Specifically, one of first conductive contact 70 and second conductive contact 80 may be positioned closer to distal surface 520 than the other, such that the conductive contacts 70, 80 are arranged in a staggered fashion. In specific embodiments, first conductive contact 70 may be connected to third conductive material 710 and second conductive contact 80 may be connected to fourth conductive material 810. These connections may be made by soldering, clamping, or any other method of connection as understood by one of ordinary skill in the art. In certain embodiments, connection to conductive materials 710 and 810 can occur through a circuit breaker/overcurrent protection device as described in more detail below. In additional embodiments, one single conductive material may comprise both first conductive contact 70 and third conductive material 710. Further, one single conductive material may comprise both second conductive contact 80 and fourth conductive material 810. In specific embodiments, third conductive material 710 and fourth conductive material 810 may extend from connector device 60 to a tap assembly of the present invention, thus acting as a conduit for electrical power to travel from the described electrical power supply system 50 to a tap assembly 10.

Each of third conductive material 710 and fourth conductive material 810 may comprise any conductive material as understood by one of ordinary skill in the art, and may specifically comprise any appropriate metal such as, without limitation, copper, silver, aluminum, steel, gold, tin, lead, nickel, or an alloy; any appropriate non-metallic conductor such as, without limitation, graphite; or any combination thereof. As shown, third conductive material 710 and fourth conductive material 810 may each comprise a round wire. Alternatively, third conductive material 710 and fourth conductive material 810 may each comprise a flat strip or any other appropriate shape. In specific embodiments, third conductive material 710 and fourth conductive material 810 may each comprise a flexible, semi-flexible, rigid or semi-rigid material.

As discussed above, in specific embodiments, first conductive material 20 may act as a powered lead and second conductive material 30 may act as a neutral lead. In such a situation, when first conductive contact 70 engages first conductive material 20, first conductive contact 70 and third conductive material 710 also become powered leads and second conductive contact 80 and fourth conductive material 810 become neutral leads. As such, electrical power can be routed through electrical power supply system 50 to a tap assembly of the present invention. Similarly, if first conductive material 20 was acting as a neutral lead and second conductive material 30 was acting as a powered lead, first conductive contact 70 and third conductive material 710 would become neutral leads and second conductive contact 80 and fourth conductive material 810 would become powered leads, thus also enabling electrical power to be routed through electrical power supply system 50 to a tap assembly of the present invention.

As will be understood by one of ordinary skill in the art, in specific embodiments, connector device 60 may comprise an over-current protection circuit. In such specific embodiments, the over-protection circuit may monitor the current voltage draw of the electrical device that it is associated with, and may terminate operation of that connector device 60 if that voltage draw exceeds a preset voltage level. In such embodiments, connector device 60 may have one or more indicators, such as, in one non-limiting example, one or more light emitting diodes (LEDs) attached to it to indicate the operation status of that connector device 60. For example, if the connector device 60 is working, a green LED may be lit, and if the connector device 60's operation has been terminated by the over-current protection circuit, a red LED may be lit. In alternative embodiments, some other notification device may be used to indicate when the over-current protection circuit has terminated operation of a connector device 60. In specific embodiments, the over-current protection circuit may be automatically resetting. For example, once a given connector device 60's operation has been terminated by an over-current protection circuit, in certain embodiments that connector device 60's operation can be restored by disconnecting it from electrical power supply system 50 and then reconnecting it. Alternatively, the system can reset by eliminating the source of fault by, without limitation, replacing faulty portions of the system. Mechanisms to achieve these benefits are understood by those of ordinary skill in the art.

In specific embodiments, connector device 60 may be used as a conduit to route electrical power from a power source to electrical power supply system 50. In such specific embodiments, the power source may be, without limitation, a standard low voltage transformer, a standard DC power supply, or any other power source as understood by one of ordinary skill in the art.

FIG. 9 depicts a tap assembly 600 of the present invention being powered by the described power supply system 610. In this depicted example, power supply system 610 is mounted to a surface 612 near the tap assembly 600. Connector 601 may carry power to power supply 610 from a source. Connector 602 carries power to the tap assembly 600. As can be seen in FIG. 9, conductive wires 615 enter the tap assembly 600 through slip ring 620. Power is routed through tap assembly 600 as described above to provide power to tap handle 650. This power can be used in a variety of ways including to generate light, noise, movement, vibration, etc.

As will be understood by one of ordinary skill in the art, ferrule wire 504 carries power to tap handle 650 (FIG. 9) to achieve a function in tap handle 650 such as, without limitation, producing light, sound, movement, etc. Light, sound and movement producing devices are well known and can include a variety of bulbs, speakers, chips, motors, etc. These non-limiting examples of devices that can be powered within tap handles of the present invention can produce a variety of displays and outcomes. Some non-limiting examples of displays and outcomes include the powering of one or more small lava lamps, disco balls or pinwheels within a clear or semi-clear tap handle. Alternatively (or in combination with the displays mentioned above), bubble systems alone or in support of a small aquarium could be powered by the systems and methods of the present invention. Tap handles according to the present invention could alternatively or in combination, blink, glow, sparkle, spin, bend, etc.

Although the present invention has been described in considerable detail with reference to certain specific embodiments, other embodiments and variations will be apparent to those of ordinary skill in the art. Therefore, the spirit and scope of the claims herein should not be limited to the description of the specific embodiments contained herein.

1. A tap assembly comprising:
a locknut;
a slip ring comprising two or more conductive elements; and
a ferrule assembly,
wherein said slip ring is positioned between said locknut and said ferrule assembly; wherein the rotational position of said slip ring can be adjusted relative to the rotational positions of said locknut and/or said ferrule assembly; and wherein said slip ring can accept conductive wires into said tap assembly so that said wires can provide power to said tap assembly.

2. (canceled)

3. A tap assembly according to claim 1, wherein said conductive elements are conductive rings.

4. A tap assembly according to claim 1, wherein said slip ring further comprises an overmold.

5. A tap assembly according to claim 1, wherein said ferrule assembly comprises a circuit board, a ferrule base, a ferrule wire, and a ferrule stud.

6. A tap assembly according to claim 1, wherein said locknut comprises a vertical indentation to restrict vertical movement of said slip ring.

7. A powered tap handle system comprising a tap assembly and a power supply system wherein said tap assembly comprises
a locknut;
a slip ring; and
a ferrule assembly,
wherein said slip ring is positioned between said locknut and said ferrule assembly;
wherein the rotational position of said slip ring can be adjusted relative to the rotational positions of said locknut and/or said ferrule assembly; and
wherein said power supply system comprises
a non-conductive protective layer comprising a top surface and a bottom surface;
a non-conductive support layer comprising a top surface and a bottom surface;
a first conductive material; and
a second conductive material,
wherein said first conductive material and said second conductive material are located between said top surface of said protective layer and said bottom surface of said support layer; wherein said non-conductive support layer is shaped to allow access to said first conductive material and said second conductive material by a first conductive contact associated with a first conductive wire and a second conductive contact associated with a second conductive wire,
wherein when engaged to said first and second conductive materials said first and second conductive contacts and associated conductive wires carry power to said tap assembly via an entry point in said slip ring.

8. A powered tap handle system according to claim 7, wherein said slip ring comprises one or more conductive elements and said ferrule assembly comprises a circuit board, a ferrule base, a ferrule wire, and a ferrule stud.

9. A ferrule assembly for use with a tap assembly wherein said tap assembly comprises
a locknut; and
a slip ring comprising two or more conductive elements,
wherein said slip ring is positioned between said locknut and said ferrule assembly; and
wherein said slip ring can accept conductive wires into said tap assembly so that said wires can provide power to said tap assembly.

10. A ferrule assembly according to claim 9, wherein said ferrule assembly comprises a circuit board, a ferrule base, a ferrule wire, and a ferrule stud.

11. A slip ring comprising two or more conductive elements, wherein said slip ring is for use with a tap assembly wherein said tap assembly comprises
a locknut; and
a ferrule assembly comprising a circuit board; a ferrule base; a ferrule wire; and a ferrule stud, wherein said slip ring is positioned between said locknut and said ferrule assembly; wherein the rotational position of said slip ring can be adjusted relative to the rotational positions of said locknut and/or said ferrule assembly, and wherein said slip ring can accept conductive wires into said tap assembly so that said wires can provide power to said tap assembly.

12. (canceled)

13. A slip ring according to claim 11, wherein said conductive elements are conductive rings.

14. A slip ring according to claim 11, wherein the rotational position of said slip ring can be adjusted relative to the rotational positions of said locknut and/or said ferrule assembly.

15. A slip ring according to claim 11, wherein said slip ring further comprises an overmold.

16. A slip ring according to claim 11, wherein said slip ring is sized to fit into a vertical indentation on said locknut.

17. A method for accepting power into a tap assembly comprising
providing a locknut;
providing a slip ring comprising two or more conductive elements; and
providing a ferrule assembly,
wherein said slip ring is positioned between said locknut and said ferrule assembly; and
wherein said slip ring accepts conductive wires into said tap assembly so that said wires can provide power to said tap assembly.

18. (canceled)

19. A method according to claim 17, wherein the rotational position of said slip ring can be adjusted relative to the rotational positions of said locknut and/or said ferrule assembly and wherein said slip ring further comprises an overmold.

20. A method according to claim 17, wherein said ferrule assembly comprises a circuit board, a ferrule base, and a ferrule stud.

21. A tap handle for use with a tap assembly wherein said tap assembly comprises:
a locknut;
a slip ring comprising two or more conductive elements; and
a ferrule assembly comprising a circuit board, a ferrule base, a ferrule wire, and a ferrule stud,
wherein said slip ring is positioned between said locknut and said ferrule assembly; wherein the rotational position of said slip ring can be adjusted relative to the rotational positions of said locknut and/or said ferrule assembly; wherein said slip ring can accept conductive wires into said tap assembly so that said wires can provide power to said tap assembly and wherein said tap handle is attached to said ferrule stud.

22. (canceled)

23. A tap handle according to claim 21, wherein said tap handle performs a function selected from the group consisting of lighting, producing sound, moving, vibrating, and combinations thereof.
